(19) United States
(12) Patent Application Publication
(10) Pub. No.: US 2024/0216889 A1
(43) Pub. Date: Jul. 4, 2024

(54) STORAGE MEDIUM FOR STORING HYDROGEN CHLORIDE AND METHOD FOR SEPARATING AND STORING HYDROGEN CHLORIDE HCL FROM HCL CONTAINING GAS

(71) Applicant: FREIE UNIVERSITÄT BERLIN, Berlin (DE)

(72) Inventors: Sebastian HASENSTAB-RIEDEL, Kleinmachnow (DE); Patrick VOßNACKER, Berlin (DE)

(73) Assignee: FREIE UNIVERSITÄT BERLIN, Berlin (DE)

(21) Appl. No.: 18/684,109

(22) PCT Filed: Aug. 11, 2022
(86) PCT No.: PCT/EP2022/072594

§ 371 Date: Feb. 15, 2024

(30) Foreign Application Priority Data
Aug. 19, 2021 (EP) 21192129.1

(51) Int. Cl. B01J 20/22; B01J 20/28; C25B 1/02; C25B 1/26

(52) U.S. Cl. CPC B01J 20/22; B01J 20/28011; C25B 1/02; C25B 1/26

(57) ABSTRACT

It is provided a storage medium for storing hydrogen chloride (HCl) comprising at least one ionic compound of the general formulae (I)

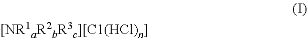

Wherein R¹, R², R³ being independent from each other an alkyl moiety selected from the group of methyl, ethyl, n-propyl, iso-propyl, n-butyl, iso-butyl and sec-butyl, preferably methyl, ethyl, n-propyl; Wherein at least one of the moieties R¹, R², R³ differs from each of the others moieties R¹, R², R³; Wherein a, b, c are independently from each other 0, 1, 2 or 3, wherein the sum of a+b+c always has to be 4; Wherein n>=1, preferably n=1-6, more preferably n=1, 2, 3, 4, with a viscosity in a range between 5 and 50 mPas, preferably between 10 and 20 mPas (25° C., 1000 hPa).

### CROSS-REFERENCE TO A RELATED APPLICATION

This application is a National Phase patent application of International Patent Application Number PCT/EP2022/072594, filed on Aug. 11, 2022, which claims priority of European Patent Application Number 21 192 129.1, filed on Aug. 19, 2021.

The disclosure relates to a storage medium for storing hydrogen chloride, the use of such a storage medium for separating of HCl from process gas and/or for reversible absorption and storage of HCl from process gas; a method for separating and storing hydrogen chloride HCl from HCl containing gas, and a method for releasing hydrogen and chlorine from the storage medium.

### BACKGROUND

Hydrogen chloride is used in the production of chlorides, fertilizers, and dyes, in electroplating, and in the photographic, textile, and rubber industries. Hydrogen chloride is typically produced by combining chlorine and hydrogen. The industrial production of hydrogen chloride is often integrated with the formation of chlorinated and fluorinated organic compounds, e.g., Teflon, Freon, and other CFCs, as well as chloroacetic acid and PVC.

Hydrogen chloride is also produced in large quantities in industry as a by-product of organic chlorination reactions.

Some of the hydrogen chloride obtained as by-product is decomposed back into chlorine and hydrogen by gas phase oxidation or electrochemical processes such as hydrochloric acid diaphragm electrolysis. These processes are all very energy intensive, use precious metal catalysts and require diaphragms or membranes during electrolysis.

Thus, it would be of an advantage to provide a method for separating HCl from industrial process gases that allows an easy and cost efficient separation of HCl.

It is in generally known that chlorides form with hydrogen chloride (HCl) poly(hydrogen chloride)chlorates(—I) of the type [Cat][Cl(HCl)n]. Examples are the symmetrical ammonium salts NR₄ (R=Me, Et, Pr, Bu, Pen). The symmetrical tetrapentylammonium bichloride is the first to be described as a liquid. In addition, the [NMe₃(C₁₆H₃₃)] and a few imidazolium-based bichlorides are known. However, the efficiency of these known compounds for absorbing HCl is not satisfying. Note, that a long alkyl chain can undergo chlorination reactions which might lead into decomposition of the material or modifies the properties of the compound, as shown for corresponding polychloride systems.

The amount of HCl absorbed by said compounds depends on different factors, such as temperature and corresponding partial pressure of the hydrogen chloride, as well as physical properties of the ionic compound. For example, the properties of the ionic compounds such as viscosities, conductivities, molar mass, etc. can be influenced by the choice and substitution of the cation, as shown for polychlorides (WO 2019215037 A1).

### SUMMARY

It was therefore an object underlying the proposed solution to provide a compound that shows an improved storage capability for HCl.

This object is solved by providing a storage medium for storing hydrogen chloride with the features as described herein and a method for separating and storing hydrogen chloride with features as described herein.

Accordingly, a storage medium for storing hydrogen chloride (HCl) comprising at least one ionic compound of the general formulae (I)

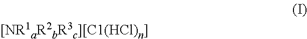

is provided,
Wherein R¹, R², R³ being independent from each other an alkyl moiety selected from the group of methyl, ethyl, n-propyl, iso-propyl, n-butyl, iso-butyl and sec-butyl-, preferably methyl, ethyl, n-propyl, n-butyl;
Wherein at least one of the moieties R¹, R², R³ differs from each of the others moieties R¹, R², R³;
Wherein a, b, c are independently from each other 0, 1, 2 or 3, wherein the sum of a+b+c always has to be 4;
Wherein n>=1, preferably n=1-6, more preferably n=1, 2, 3, 4, and
with a viscosity in a range between 5 and 50 mPas, preferably between 10 and 20 mPas (25° C., 1000 hPa).

Viscosity was measured using a Ubbelohde viscosimeter for determination of the kinematic viscosity according DIN 51 562-2. The dynamic viscosity was calculated from the kinematic viscosity after determination of the density.

The ionic liquid compound of formulae (I) allows for a reversible absorption and storage of HCl from process gas. Another advantage is that hydrogen H₂ can be released from compound (1) by electrolysis in an electrochemical process. Further storage of chlorine Cl₂ in the ionic liquid is possible that can be used as Cl₂ source for further synthetic applications, such as synthesis of phosgen (Voßnacker et al., Novel Synthetic Pathway for the Production of Phosgene, Science Advances 2021, 7, eabj5186).

The storage medium for HCl according to the solution comprises an ionic compound, in particular an ionic liquid, made of an asymmetrically substituted ammonium cation and poly(HCl)chloride anion. The cation is an ammonium cation that has at least two different alkyl moieties. The ammonium cation may have two, three or four different alkyl moieties, in particular lower alkyl moieties.

The ionic liquid according to the solution has a low viscosity, high electrical conductivity, low decomposition voltage, low molar mass. Furthermore, these compounds are easy to synthesize and can be produced in large quantities from very cheap chemicals.

Moreover, the ionic liquid can be decomposed into hydrogen and chlorine by electrolysis at a low cell voltage. Thus, the ionic liquid can be used as an anhydrous system to produce chlorine and hydrogen.

The ionic liquid of the storage system according to the solution has several advantages: the IL shows low corrosion; efficient storage of HCl with simultaneous purification of other impurities, since they are not absorbed by the ionic liquid; electrolysis shows significant gas evolution only at one electrode, thus easier separation of the resulting products is available; possible simpler cell design of the electrolysis; potential avoidance of diaphragms or membranes in the cell; carbon electrodes may be used instead of expensive precious metals as electrode material.

In an embodiment of the present storage medium a, b=1, 2 or 3, and c=0, 1 in the ionic compound of general formula (I).

In a further embodiment of the present storage medium the ionic compound of general formula (I) is selected from [NEt₃Me][Cl(HCl)ₙ], [NEt₂Me₂][Cl(HCl)ₙ], [NEtMe₃][Cl(HCl)ₙ], [NBuEt₂Me][Cl(HCl)ₙ], [NPr₃Me][Cl(HCl)ₙ], [NBu₂Me₂][Cl(HCl)ₙ], [NBu₃Me][Cl(HCl)ₙ, with n being 1-6, preferably 1-4. It is to be understood that n can be any possible number between 1 and 6, preferably between 1 and 4. There is an equilibrium between different [Cl(HCl)ₙ]⁻ (n=1-4) species in the liquid.

In a preferred embodiment of the present storage medium the ionic compound of general formula (I) is selected from [NEt₃Me][Cl(HCl)ₙ], [NEt₂Me₂][Cl(HCl)ₙ], [NEtMe₃][Cl(HCl)ₙ], with n being 1-6, preferably 1-4.

In still a further embodiment of the present storage medium the ionic compound of general formula (I) contains (in the loaded state) at least 0.3 g HCl/g ionic compound, preferably at least 0.4 g HCl/g ionic compound, more preferably at least 0.5 g HCl/g ionic compound. Thus, the storage capacity by mass may be between 0.3 and 1 g HCl/g ionic compound, preferably between 0.4 and 0.8 g HCl/g ionic compound, more preferably between 0.5 and 0.7 g HCl/g ionic compound. The storage capacity was determined as follows: A defined amount of chloride salt was loaded into a Schlenk flask. The chloride salt was loaded with HCl as described in the Example 1 and 2. The amount of HCl stored on the chloride salt was determined by weighing.

The storage capacity by amount of substance may be at least 1.5 mol/mol ionic compound, preferably at least 2.0 mol/mol ionic compound, more preferably at least 2.5 mol/mol ionic compound. The range of storage capacity by amount of substance may be between 1.5 and 3 mol/mol ionic compound, preferably between 2.0 and 2.8 mol/mol ionic compound, more preferably between 2.2 and 2.6 mol/mol ionic compound.

Furthermore, the present storage medium has a conductivity of at least 20 mS/cm (20° C.), preferably at least 30 mS/cm, more preferably at least 40 mS/cm, even more preferably at least 50 mS/cm. The conductivity was determined using a SevenCompact S230 Conductivity meter from Mettler Toledo.

The density of the present storage medium may be in a range between 0.5 and 1.5 kg/L, preferably between 0.8 and 1.2 kg/L, more preferably between 0.9 and 1.1 kg/L. Densities are determined by using a Schlenk tube with a volume scale in which a defined volume of the substance is weighted.

In an embodiment of the present storage medium a hydrogen H₂ development is detectable at at least 1 V, preferably at least 0.8 V, more preferably at least 0.5 V, such as in the range of 1-1.5 V, preferably in the range of 1-1.2 V.

As mentioned, the storage medium according to the solution may be used for separating of HCl from process gas and/or for reversible absorption and storage of HCl from process gas.

This is done in a method for separating and storing hydrogen chloride HCl from HCl containing gas, in particular HCl containing process gas,
wherein the HCl containing gas is contacted with at least one ionic compound of general formulae (II)

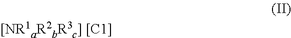

Wherein R¹, R², R³ being independent from each other an alkyl moiety selected from the group of methyl, ethyl, n-propyl, iso-propyl, n-butyl, iso-butyl and sec-butyl, preferably methyl, ethyl, n-propyl;
Wherein at least one of the moieties R¹, R², R³ differs from each of the others moieties R¹, R², R³;
Wherein a, b, c are independently from each other 0, 1, 2 or 3, wherein the sum of a+b+c always has to be 4;
Wherein the hydrogen chloride HCl from the HCl containing gas is bound by the at least one ionic compound of general formulae (II) thereby providing the ionic compound of general formulae (I)

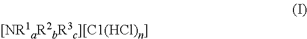

Wherein R¹, R², R³ being independent from each other an alkyl moiety selected from the group of methyl, ethyl, n-propyl, iso-propyl, n-butyl, iso-butyl and sec-butyl, preferably methyl, ethyl, n-propyl;
Wherein at least one of the moieties R¹, R², R³ differs from each of the others moieties R¹, R², R³;
Wherein a, b, c are independently from each other 0, 1, 2 or 3, wherein the sum of a+b+c always has to be 4;
Wherein n>=1, preferably n=1-6, more preferably n=1, 2, 3, 4.

In an embodiment of the present method the ionic compound of general formula (II) is selected from [NEt₃Me][Cl], [NEt₂Me₂][Cl], [NEtMe₃][Cl], [NBuEt₂Me][Cl], [NPr₃Me][Cl], [NBu₂Me₂][Cl], preferably from [NEt₃Me][Cl], [NEt₂Me₂][Cl], [NEtMe₃][Cl].

As mentioned previously, the hydrogen chloride stored in the ionic compound of general formulae (I) of the storage medium may be released form said compound if needed.

In an embodiment the hydrogen chloride HCl stored in the ionic compound of general formulae (I) is split into hydrogen H₂ and chlorine Cl₂ by electrolysis, specifically by applying a cell voltage of at least 1 V, preferably at least 0.8 V, more preferably at least 0.5 V, such as in the range of 1-1.5 V, preferably in the range of 1-1.2 V.

Simultaneously to the release of hydrogen and chlorine the compound of general formulae (II) is obtained. Compound of formulae (II) may be recycled for reuse as HCl storage medium.

In a further embodiment the chlorine Cl₂ released and obtained during electrolysis is (immediately) stored, in particular in the ionic compound of general formulae (II), providing an ionic compound of general formulae (III)

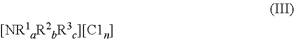

Wherein R¹, R², R³ being independent from each other an alkyl moiety selected from the group of methyl, ethyl, n-propyl, iso-propyl, n-butyl, iso-butyl and sec-butyl, preferably methyl, ethyl, n-propyl;
Wherein at least one of the moieties R¹, R², R³ differs from each of the others moieties R¹, R², R³;
Wherein a, b, c are independently from each other 0, 1, 2 or 3, wherein the sum of a+b+c always has to be 4;
Wherein n>=1, preferably n=1-7, more preferably n=3, 5, 7.

The storage of chlorine from chlorine containing gases is described for example in WO 2019/215037 A1.

### BRIEF DESCRIPTION OF THE DRAWINGS

The solution is now explained in more detail by means of examples with reference to the figures.

FIG. 1 shows a scheme of using a compound of the storage medium according to the solution for bonding and storing HCl and conversion of HCl to chlorine and hydrogen.

FIG. 2 shows a scheme of using a compound of the storage medium according to the solution for bonding and storing HCl, conversion of HCl to chlorine and hydrogen, subsequent storage of chlorine and its conversion to chemical products such as phosgene.

FIG. 3 shows a molecular structure in the solid state of [NEt₃Me][ClHCl].

FIG. 4 shows a current over voltage diagram of [NEt₃Me][ClHCl].

FIG. 5 shows a current over time diagram of [NEt₃Me][ClHCl].

FIG. 6 shows a UV/Vis spectrum of the gas phase after electrolysis of [NEt₃Me][ClHCl].

FIG. 7 shows a NMR spectrum of [NEt₃Me][ClHCl] after electrolysis.

### DETAILED DESCRIPTION

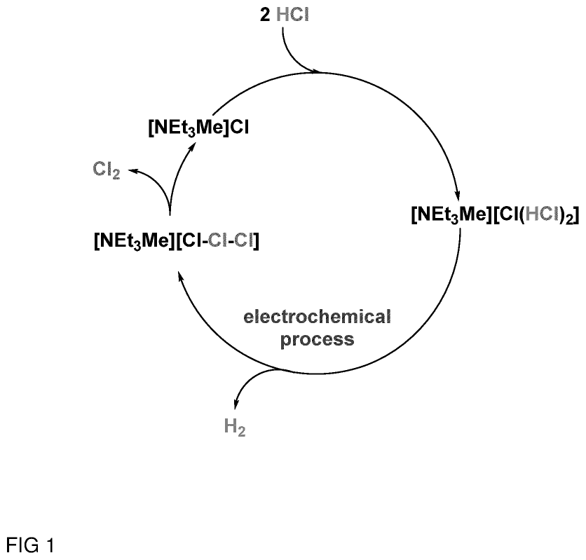

FIG. 1 illustrates a cycle for storage of HCl using an ionic compound of formulae (II) under formation of an ionic compound of formulae (I) and subsequent release of hydrogen and chlorine under electrolytic conditions.

Accordingly, 2 molecules HCl are absorbed by [NEt₃Me]Cl providing [NEt₃Me][Cl(HCl)₂]. When applying a voltage of about 1-1.2 V to [NEt₃Me][Cl(HCl)₂] the hydrogen chloride HCl stored in the ionic compound is split into hydrogen H₂ and chlorine Cl₂.

The chlorine Cl₂ released and obtained during electrolysis is (immediately) stored as [NEt₃Me][Cl—Cl—Cl] and subsequently released.

Simultaneously to the release of hydrogen and chlorine [NEt₃Me]Cl is obtained that is recycled for reuse as HCl storage medium.

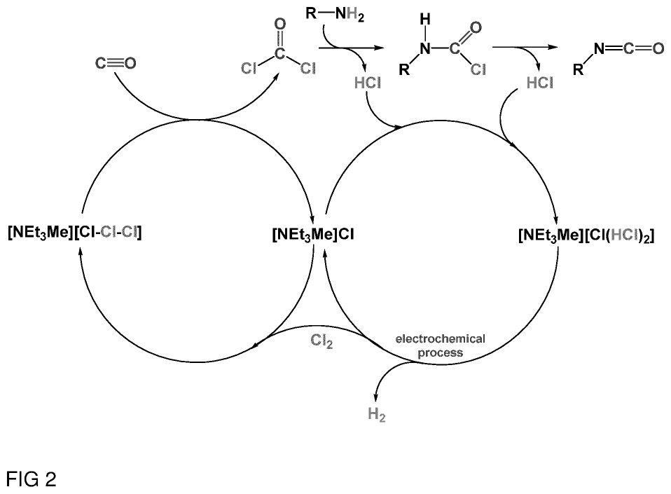

In the larger context of FIG. 2, a cycling process for chlorine can thus be established, as the ionic liquid formed [NEt₃Me][Cl₃] is reacted again with CO to form phosgene, which is further reacted with amines to form isocyanates and HCl.

### Example 1

[NEt₃Me]Cl (36.2 g, 239 mmol) were dried at 150° C. for 1 hour to remove residual moisture. The dry salt was placed in a flask which was evacuated. Hydrogen chloride gas was introduced into the flask (18.5 g, 507 mmol, 2.12 equiv.) until the system retains a constant pressure of 950 mbar. A low viscous, colorless liquid, which stores 0.51 g HCl per g storage medium, is obtained.

The obtained compound can be described as [NEt₃Me][Cl(HCl)_{2.16}] which means there are 2.16 equivalents of HCl per Chloride. There is an equilibrium between different [Cl(HCl)ₙ]⁻ (n=1-4) species in the liquid. This was demonstrated for comparable [F(HF)ₙ]⁻ systems using NMR spectroscopy. The most stable [Cl(HCl)ₙ] species is the [ClHCl]⁻ anion of which also a molecular structure in the solid state was obtained.

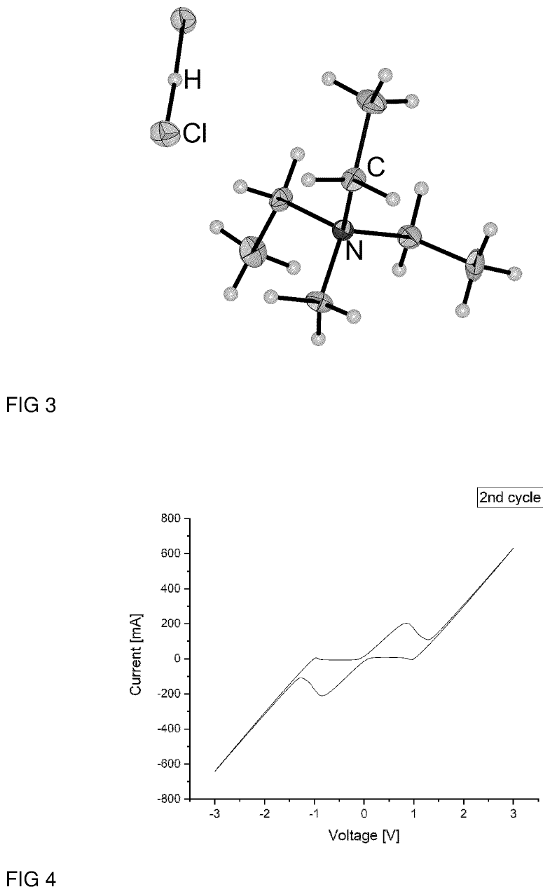

FIG. 3 shows the molecular structure of [NEt₃Me][ClHCl] in the solid state.

Properties of [NEt₃Me][Cl(HCl)_{2.16}] were determined: Conductivity: 62.6 mS/cm at 25° C.; Viscosity: 12 mPa s, Density: 1.03 g/mL.

[NEt₃Me][Cl(HCl)_{2.16}] was characterized by current-voltage (CV) experiments (see Diagram of FIG. 4) and current-time experiments (see Diagram of FIG. 5). A gas evolution at the cathode was observed and a change of color to yellow was observed. Electrolysis at 3 V for 2 h intensify the yellow color.

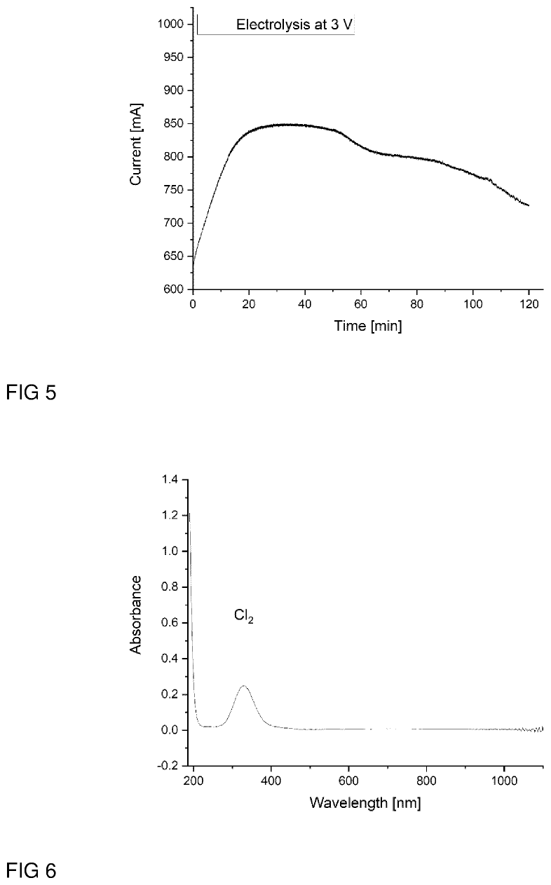

Characterization of the gas phase via UV/Vis showed the formation of chlorine (see diagram of FIG. 6).

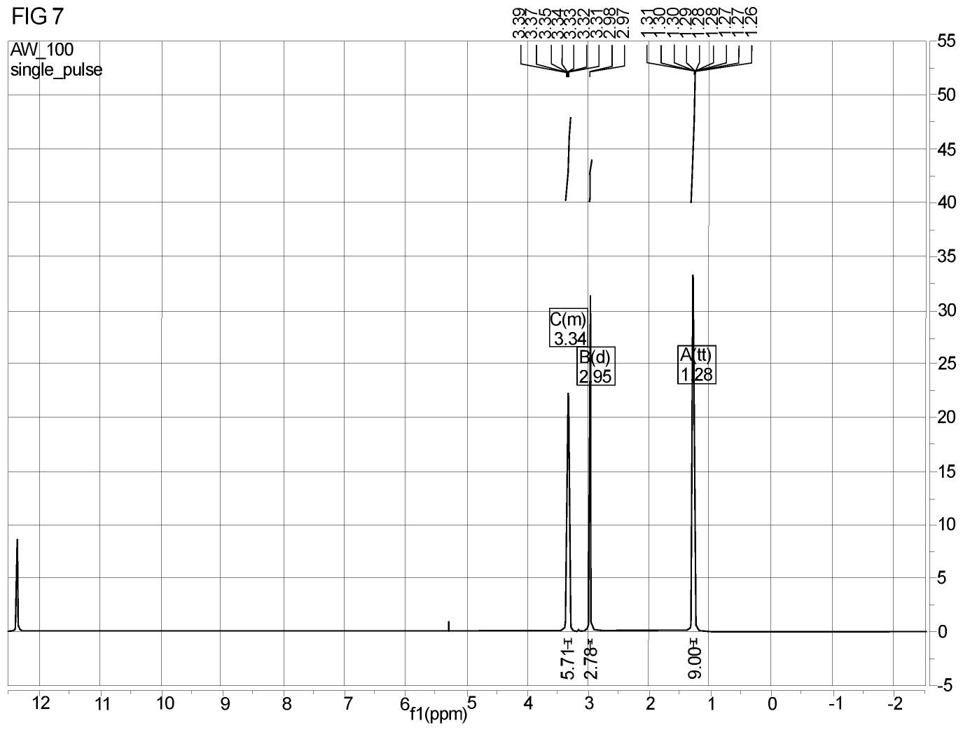

1H NMR spectra of the remaining IL showed the signals for the cation and ClHCl (see diagram of FIG. 7).

### Example 2

[NMePr₃]Cl (1.52 g, 7.72 mmol) were dried at 150° C. for 1 hour to remove residual moisture. Hydrogen chloride was added to the system (0.757 g, 20.8 mmol, 2.69 equiv.). A low viscous, colorless liquid, which stores 0.50 g HCl per g storage medium, is obtained.

Further studies on [NR₃Me][Cl(HCl)ₙ] systems were performed and the following storage capacities, densities, dynamic viscosities and conductivities were determined. The samples of the loaded system were prepared as described above for [NEt₃Me]Cl.

TABLE 1
Storage capacities of [NR₃Me]Cl and physical
properties of [NR₃Me][Cl(HCl)ₙ]

| | | | | Storage | Storage |
|---|---|---|---|---|---|
| | | | Conduc- | capacity | capacity |
| | | Dynamic | tivity | by amount of | by mass |
| | Density | viscosity | at 25° C. | substance | [kg |
| Substrate | [kg L⁻¹] | [mPa s] | [mS cm⁻¹] | [mol mol⁻¹]^{[a]} | kg⁻¹]^{[b]} |
| [NEt₃Me]Cl | 1.03 | 12 | 62.6 | 2.16 | 0.51 |
| [NEt₂Me₂]Cl | 0.98 | 7 | 70.1 | 2.07 | 0.55 |
| [NPr₃Me]Cl | 0.93 | 14 | 24.0 | 2.69 | 0.50 |
| [NBu₃Me]Cl | 0.94 | 26 | 9.8 | 2.57 | 0.40 |

^{[a]}Storage capacity by amount of substance is equal to the amount of substance of HCl which can be stored on 1 mol of the chloride salt.
^{[b]}Storage capacity by mass is equal to the mass of HCl which can be stored on 1 kg of the chloride salt.

1. A storage medium for storing hydrogen chloride (HCl) comprising at least one ionic compound of the general formulae (I) 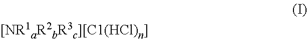
Wherein R¹, R², R³ being independent from each other an alkyl moiety selected from the group of methyl, ethyl, n-propyl, iso-propyl, n-butyl, iso-butyl and sec-butyl, preferably methyl, ethyl, n-propyl, n-butyl;
Wherein at least one of the moieties R¹, R², R³ differs from each of the others moieties R¹, R², R³;
Wherein a, b, c are independently from each other 0, 1, 2 or 3, wherein the sum of a+b+c always has to be 4;
Wherein n>=1, preferably n=1-6, more preferably n=1, 2, 3, 4, and
With a viscosity in a range between 5 and 50 mPas, preferably between 10 and 20 mPas (25° C., 1000 hPa).

2. The storage medium according to claim 1, wherein in the ionic compound of general formula (I) a, b=1, 2 or 3, and c=0, 1.

3. The storage medium according to claim 1, wherein the ionic compound of general formula (I) is selected from [NEt₃Me][Cl(HCl)ₙ], [NEt₂Me₂][Cl(HCl)ₙ], [NEtMe₃][Cl(HCl)ₙ], [NBuEt₂Me][Cl(HCl)ₙ], [NPr₃Me][Cl(HCl)ₙ], [NBu₂Me₂][Cl(HCl)ₙ], with n being 1-6, preferably 1-4.

4. The storage medium according to claim 1, wherein the ionic compound of general formula (I) is selected from [NEt₃Me][Cl(HCl)ₙ], [NEt₂Me₂][Cl(HCl)ₙ], [NEtMe₃][Cl(HCl)ₙ], with n being 1-6, preferably 1-4.

5. The storage medium according to claim 1, wherein the ionic compound of general formula (I) contains (in the loaded state) at least 0.3 g HCl/g ionic compound, preferably at least 0.4 g HCl/g ionic compound, more preferably at least 0.5 g HCl/g ionic compound.

6. The storage medium according to claim 1, having a conductivity of at least 20 mS/cm (20° C.), preferably at least 30 mS/cm, more preferably at least 40 mS/cm, even more preferably at least 50 mS/cm.

7. The storage medium according to claim 1, having a hydrogen H₂ development at at least 1 V, preferably at least 0.8 V, more preferably at least 0.5 V, such as in the range of 1-1.5 V, preferably in the range of 1-1.2 V.

8. (canceled)

9. A method for separating and storing hydrogen chloride HCl from HCl containing gas, in particular HCl containing process gas, by contacting the HCl containing gas with at least one ionic compound of general formulae (II) 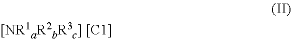
Wherein R¹, R², R³ being independent from each other an alkyl moiety selected from the group of methyl, ethyl, n-propyl, iso-propyl, n-butyl, iso-butyl and sec-butyl, preferably methyl, ethyl, n-propyl,
Wherein at least one of the moieties R¹, R², R³ differs from each of the others moieties R¹, R², R³,
Wherein a, b, c are independently from each other 0, 1, 2 or 3, wherein the sum of a+b+c always has to be 4;
Wherein the hydrogen chloride HCl from the HCl containing gas is bound by the at least one ionic compound of general formulae (II) thereby providing the ionic compound of general formulae (I) 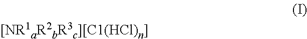
Wherein R¹, R², R³ being independent from each other an alkyl moiety selected from the group of methyl, ethyl, n-propyl, iso-propyl, n-butyl, iso-butyl and sec-butyl, preferably methyl, ethyl, n-propyl;
Wherein at least one of the moieties R¹, R², R³ differs from each of the others moieties R¹, R², R³;
Wherein a, b, c are independently from each other 0, 1, 2 or 3, wherein the sum of a+b+c always has to be 4;
Wherein n>=1, preferably n=1-6, more preferably n=1, 2, 3, 4.

10. The method according to claim 9, wherein the ionic compound of general formula (II) is selected from [NEt₃Me][Cl], [NEt₂Me₂][Cl], [NEtMe₃][Cl], [NBuEt₂Me][Cl], [NPr₃Me][Cl], [NBu₂Me₂][Cl], preferably from [NEt₃Me][Cl], [NEt₂Me₂][Cl], [NEtMe₃][Cl].

11. A method for releasing hydrogen and chlorine from an ionic compound of general formulae (I) according to claim 1, wherein the hydrogen chloride HCl stored in the ionic compound of general formulae (I) is split into hydrogen H₂ and intermediate chlorine Cl₂ by electrolysis and the compound of general formulae (II) is obtained.

12. The method according to claim 11, wherein the intermediate chlorine Cl₂ obtained during electrolysis is stored in the ionic compound of general formulae (II) providing an ionic compound of general formulae (III) 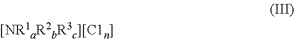
Wherein R¹, R², R³ being independent from each other an alkyl moiety selected from the group of methyl, ethyl, n-propyl, iso-propyl, n-butyl, iso-butyl and sec-butyl, preferably methyl, ethyl, n-propyl;
Wherein at least one of the moieties R¹, R², R³ differs from each of the others moieties R¹, R², R³,
Wherein a, b, c are independently from each other 0, 1, 2 or 3, wherein the sum of a+b+c always has to be 4;
Wherein n>=1, preferably n=1-7, more preferably n=3, 5, 7.
